(19) United States
(12) Patent Application Publication
(10) Pub. No.: US 2004/0085295 A1
(43) Pub. Date: May 6, 2004

(54) Pivotal joystick base

(76) Inventor: John R. Cowen, Naples, FL (US)

Correspondence Address: Edward M. Livingston, 963 Trail Terrace Drive, Naples, FL, 34103, US

(21) Appl. No.: 10/691,932

(22) Filed: Oct. 23, 2003

Related U.S. Application Data
(63) Continuation-in-part of application No. 10/162,104, filed on Jun. 3, 2002.
(63) Continuation-in-part of application No. 09/966,622, filed on Oct. 1, 2001, now abandoned.

(51) Int. Cl. G09G 5/08

(52) U.S. Cl. 345/161

(57) ABSTRACT

A pivotal joystick base has a base bar (1) with a pivot end and a base end. The pivot end is pivotal horizontally on a base pivot (2) positioned on a chair attachment (3) that is fixable to a motorized chair (4). The base end is adapted to support a joystick assembly (5) for operating the motorized chair. The base pivot includes a pivot lock for locking the joystick base in a pivoted position laterally from the base pivot to prevent contact of the joystick assembly with tables, desks, workstations, walls and other approachable objects (17) selectively. The base end can include an assembly fastener (31) for rotating the joystick assembly to a forward position in compensation for rotational positioning of the joystick assembly by lateral pivoting of the joystick base. The joystick base can have a linear mount that includes a slot (32) for linear distancing of the joystick assembly from the base pivot selectively.

### BACKGROUND OF THE INVENTION

This invention relates to pivotal positioning of joystick bases for powered wheelchairs and other mechanisms.

Joysticks for controlling powered wheelchairs generally extend forwardly from armrests where the joysticks and joystick assemblies often obstruct desirable closeness of the wheelchairs and occupants thereof to tables, desks, workstations and other structures. There are no known adjusters of distance and lateral positioning of joystick bases from the armrests to allow closeness of the powered wheelchairs to desired-objects conveniently, reliably and inexpensively in a manner taught by this invention.

Examples of most-closely related known but different devices are described in the following patent documents:

| U.S. Pat. No. | | |
|---|---|---|
| (U.S. unless stated otherwise) | Inventor | Filing Date |
| 5,326,063 | Stevens | Jul. 5, 1994 |
| 5,893,607 | Trimnell | Apr. 13, 1999 |
| 6,086,156 | Breen, et al. | Jul. 11, 2000 |
| 5,169,210 | Fricano | Dec. 8, 1992 |
| 6,352,302 | Piretti, Jr. | Mar. 5, 2002 |
| 5,026,114 | Miller | Jun. 25, 1991 |
| 5,954,393 | Perrin | Sep. 21, 1999 |
| 5,947,501 | Osborn | Sep. 7, 1999 |

### SUMMARY OF THE INVENTION

Objects of patentable novelty and utility taught by this invention are to provide a pivotal joystick base which:

allows a forwardly obstructive joystick assembly to be moved conveniently to a non-obstructive position laterally to a side of a chair member to which the joystick base is attached pivotally;

provides locking of the joystick base in the non-obstructive position for operation of the joystick in a non-obstructive position;

provides linear positioning of the joystick base from the chair member;

provides directional positioning of a joystick assembly on the joystick base selectively; and

is inexpensive.

This invention accomplishes these and other objectives with a pivotal joystick base having a pivot end and a base end. The pivot end is pivotal horizontally on a base pivot that is affixed to a chair attachment. The base end is adapted to support a joystick assembly. The base pivot includes a pivot lock with which the joystick base is lockable in a pivoted position selectively. The base end can include an assembly pivot with which the joystick assembly is rotative to a forward position in compensation for rotational positioning of the joystick assembly by lateral pivoting of the joystick base. The joystick base can include a linear mount for linear distancing of the joystick assembly from the base pivot selectively.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a side elevation view of a pivotal joystick base having a pivot lock with a spring-pressured member and mounted on a dashed-line representation of a motorized wheel chair;

FIG. 2 is a partially cutaway and expanded view of the pivotal joystick base shown in FIG. 1;

FIG. 3 is a front elevation view of the dashed-line representation of the motorized wheelchair on which the FIG. 1 pivotal joystick base is positioned with a dashed-line representation of a joystick base pivoted laterally to a side;

FIG. 4 is an expanded fragmentary top view of the FIG. 1 pivotal joystick base pivoted laterally;

FIG. 5 is a bottom view of the FIG. 4 illustration;

FIG. 6 is a partially cutaway side elevation view of the pivotal joystick base having a pivot lock with a pivot lock having a latch that is movable downwardly from a latch knob to a latch notch proximate a base pivot;

FIG. 7 is an expanded fragmentary top view of the FIG. 6 pivotal joystick base with a dashed-line representation of the base bar pivoted laterally from an armrest of the motorized wheelchair;

FIG. 8 is a partially cutaway and expanded fragmentary side view of the pivot lock of the FIG. 6 illustration;

FIG. 9 is a partially cutaway and expanded fragmentary top view of the pivot end of the base rod of the FIG. 6 embodiment;

FIG. 10 is a partially cutaway and expanded fragmentary side view of the chair attachment of the FIG. 6 embodiment;

FIG. 11 is a partially cutaway and expanded fragmentary top view of the chair attachment of the FIG. 10 illustration;

FIG. 12 is a partially cutaway top view of the FIG. 6 embodiment showing selectively lateral positioning and forward rotating of the joystick assembly;

FIG. 13 is a partially cutaway and expanded fragmentary top view of the FIG. 6 embodiment showing selectively linear and rotational positioning of the joystick assembly on the base rod;

FIG. 14 is a partially cutaway side elevation view of the FIG. 6 embodiment with a flush knob and having an attachment plate on the chair attachment;

FIG. 15 is a partially cutaway and expanded fragmentary top view of the FIG. 6 embodiment showing the attachment plate on the chair attachment;

FIG. 16 is a partially cutaway and expanded fragmentary side view of the FIG. 1 embodiment showing the attachment plate on the chair attachment; and

FIG. 17 is a partially cutaway side view of the FIG. 6 embodiment having a resilient section in the latch.

### DESCRIPTION OF PREFERRED EMBODIMENT

Listed numerically below with reference to the drawings are terms used to describe features of this invention. These terms and numbers assigned to them designate the same features throughout this description.

| | |
|---|---|
| 1. Basebar | 18. Stop |
| 2. Base pivot | 19. Lock-notch surface |
| 3. Chair attachment | 20. Pivot base |
| 4. Motorized chair | 21. Lock notch |
| 5. Joystick assembly | 22. Latch |
| 6. Pivot axle | 23. Latch aperture |
| 7. Spring-pressured member | 24. Latch tip |
| 8. Positional recess | 25. Bar knob |
| 9. Spring | 26. Actuator portion |
| 10. Adjustment bolt | 27. Latch knob |
| 11. Lock cylinder | 28. Flush knob |
| 12. Attachment bar | 29. Knob bay |
| 13. Attachment plate | 30. Fastener aperture |
| 14. Fasteners | 31. Assembly fastener |
| 15. Fastener orifices | 32. Slot |
| 16. Armrest | 33. Assembly knob |
| 17. Approachable object | 34. Resilient section |

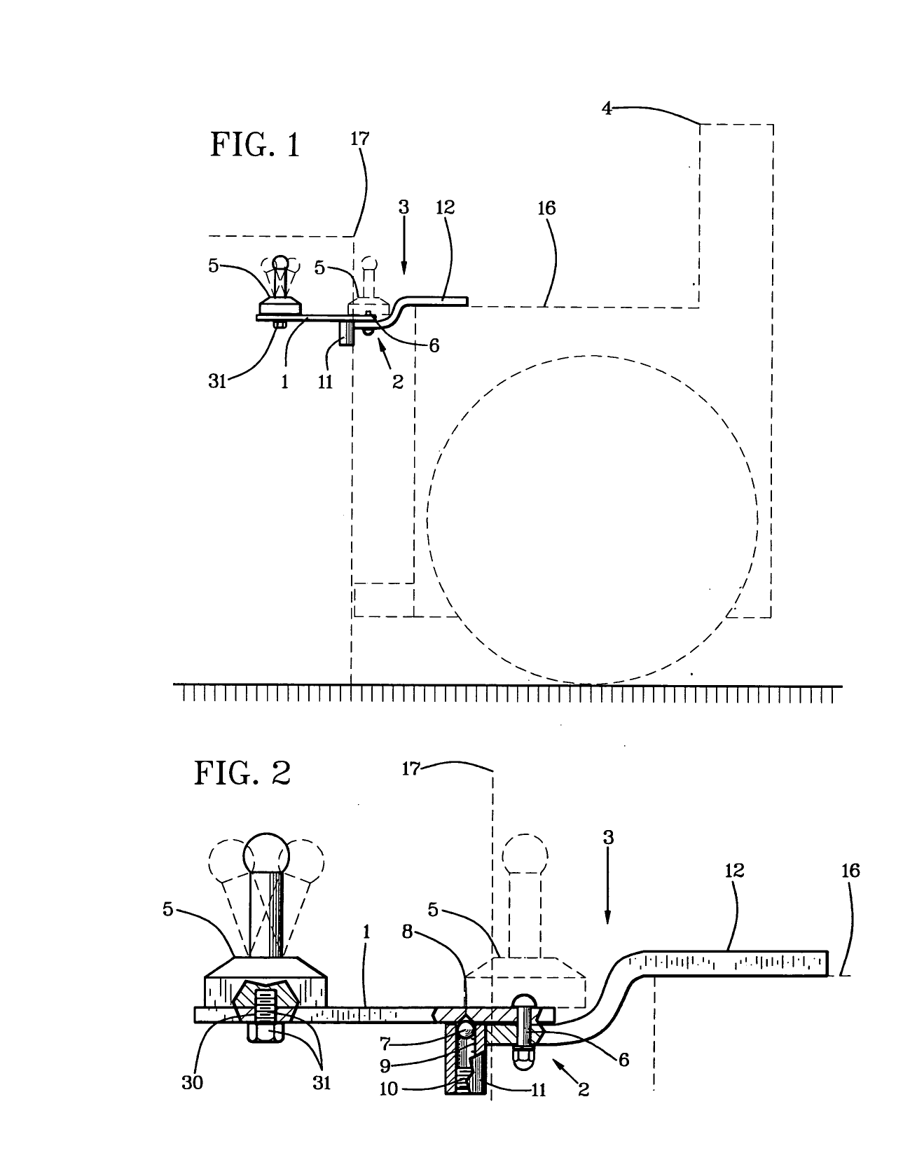

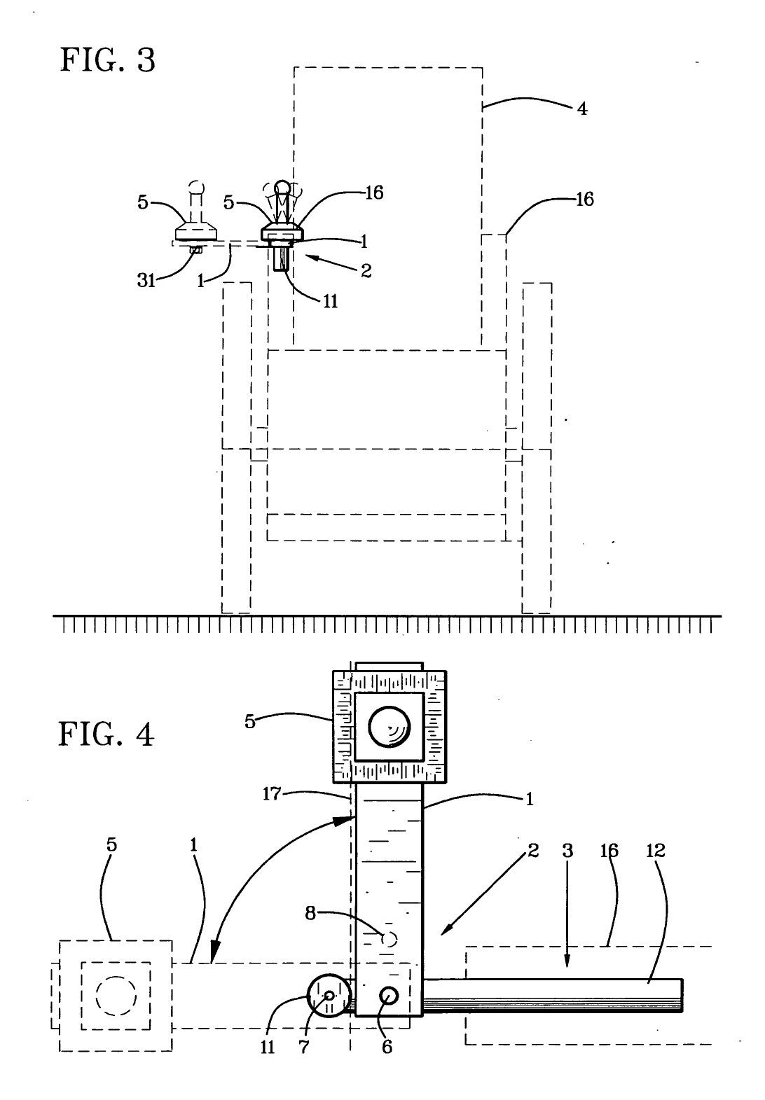

Referring to FIGS. 1-5, a pivotal joystick base has a base bar 1 with a pivot end and a base end. The pivot end is pivotal horizontally on a base pivot 2 that is affixed to a chair attachment 3 that is articulated for attachment to a motorized chair 4 predeterminedly. The base end is adapted to support a joystick assembly 5. The base pivot 2 has a pivot lock for locking the base bar 1 in a pivoted position selectively.

In a first preferred embodiment, the base pivot 2 includes a pivot axle 6 that is oriented vertically on the chair attachment 3 for horizontal pivoting of the base bar 1. The pivot lock includes a spring-pressured member 7 that is preferably a sphere or a ball which is spring-pressured upwards vertically into contact with an underside of the base bar 1 and into at least one positional recess 8 in the underside of the base bar 1 for soft-locking the spring-pressured member 7 in the positional recess 8 at a pivotal position of the base bar 1 predeterminedly.

The spring-pressured member 7 is spring-pressured upwards vertically with a spring 9 having spring pressure variable with an adjustment bolt 10 having an axis that is collinear to an axis of the spring-pressured member 7 for entrance into the positional recess 8. The spring-pressured member 7, which is preferably a sphere or ball as shown, is positioned in a top portion of a lock cylinder 11 in which a preferably helical spring 9 is positioned below the spring-pressured member. The adjustment bolt 10, preferably a recessed set-screw, is threaded into a bottom portion of the lock cylinder 11 for adjusting tension of the helical spring 9 against the spring-pressured member 7.

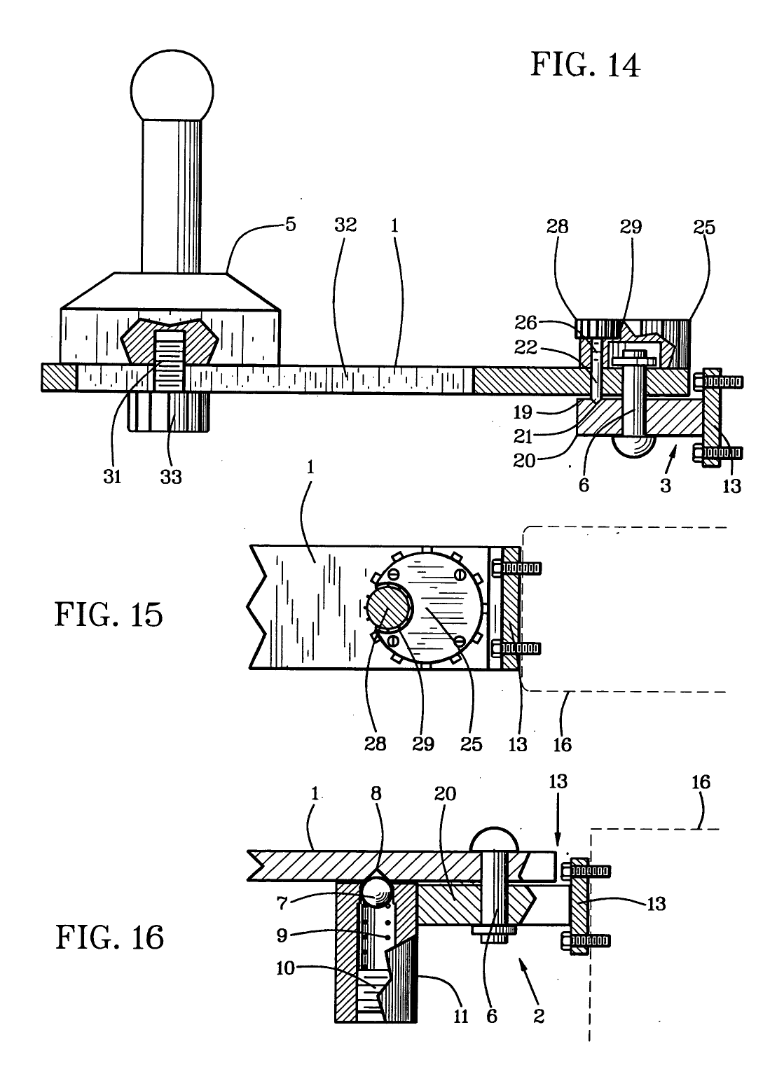

The chair attachment can include an attachment bar 12 as shown in FIGS. 1-2, 4-7, and 10-13, or an attachment plate 13 with fasteners 14 in fastener orifices 15 as shown in FIGS. 14-16. The attachment bar 12 or the attachment plate 13 are articulated for being fastened to particular structures of the motorized chair 4 preferably and usually proximate an armrest 16 on either a left or a right side of the motorized chair 4.

The pivotal joystick base allows the armrests 16 of the motorized chair 4 to be positioned closer to and quite often under an approachable object 17 which is shown in dashed lines in FIGS. 1-2, and 4-7 to represent a table, desk, workstation, wall, door or other approachable object 17. Usually, the joystick assembly 5 on a motorized chair 4 protrudes approximately six inches in front of the armrest 16. This prevents a user of the motorized chair 4 from getting close enough to the table, desk, workstation, wall, door or other approachable object 17 to use it effectively. With the pivotal joystick base, the joystick assembly 5 can be swung, pushed or pivoted to a side or backwards where it is out of the way.

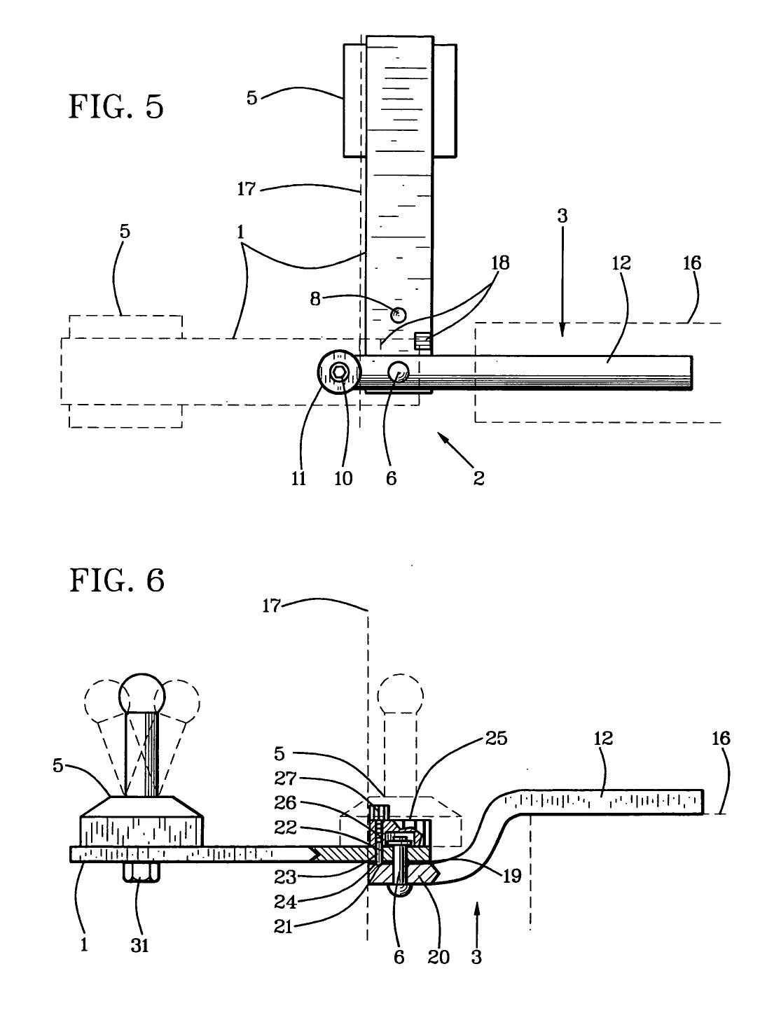

In the embodiments shown in FIGS. 1-5, the base bar 1 is soft-locked in a forward position from which there can be an easy breakaway laterally to a side or slightly backwards if desired. Preferably for most users, however, there is also a stop 18 on a bottom side of the base bar 1 as shown in FIG. 5 for contacting the chair attachment 3 to prevent inward pivoting of the base bar 1 to a position of contact of the base end with a front portion of a user.

Referring to FIGS. 6-15 and 17, a second preferred embodiment has the pivot axle 6 extended upwards vertically from a lock-notch surface 19 on the chair attachment 3 for horizontal pivoting of the base bar 1 on the pivot axle 6 vertically above the lock-notch surface 19 which can be on a pivot base 20 on the chair attachment 3. The lock-notch surface 19 includes a predetermined plurality of lock notches 21 positioned predeterminedly circumferential at a design notch distance radially from the pivot axle 6. The pivot lock includes a latch 22 that is movable upwardly and downwardly in a latch aperture 23 in the base rod 1 at the notch distance from the pivot axle 6. The latch 22 includes a latch tip 24 that is positioned in a select one of the lock notches 21 for locking the base bar 1 in a selected pivotal direction from the pivot axle 6. The latch tip 24 is removed from any of the lock notches 21 for pivoting the base bar 1 to a selected pivotal direction from the pivot axle 6. The lock notches 21 are articulated to receive the latch tip 24 predeterminedly.

The latch 22 can include a latch actuator in a bar nob 25 that is affixable to a topside of the pivot end of the base bar 1. The latch actuator can include internal fastener threads in the bar knob 25 and matching external threads in an actuator portion 26 of the latch 22. The latch 22 can have a latch handle which can include a latch knob 27 for rotating the latch 22 in an upward-rotational direction to unscrew the latch tip 24 from any one of the lock notches 21 and for rotating the latch 22 in a downward-rotational direction to screw the latch tip 24 into a select one of the lock notches 21.

As shown in FIGS. 14-15, the latch 22 can include a recessed flush knob 28 that is recessed in a knob bay 29 in the bar knob 25.

The latch tip 24 is preferably conical and the lock notches 21 are matched conically for receiving the latch tip 24.

As shown in FIGS. 1-2, the base bar 1 includes a fastener aperture 30 through which an assembly fastener 31 is inserted and tightened to position the joystick assembly 5 in a desired rotational direction for joystick control of the motorized chair 4.

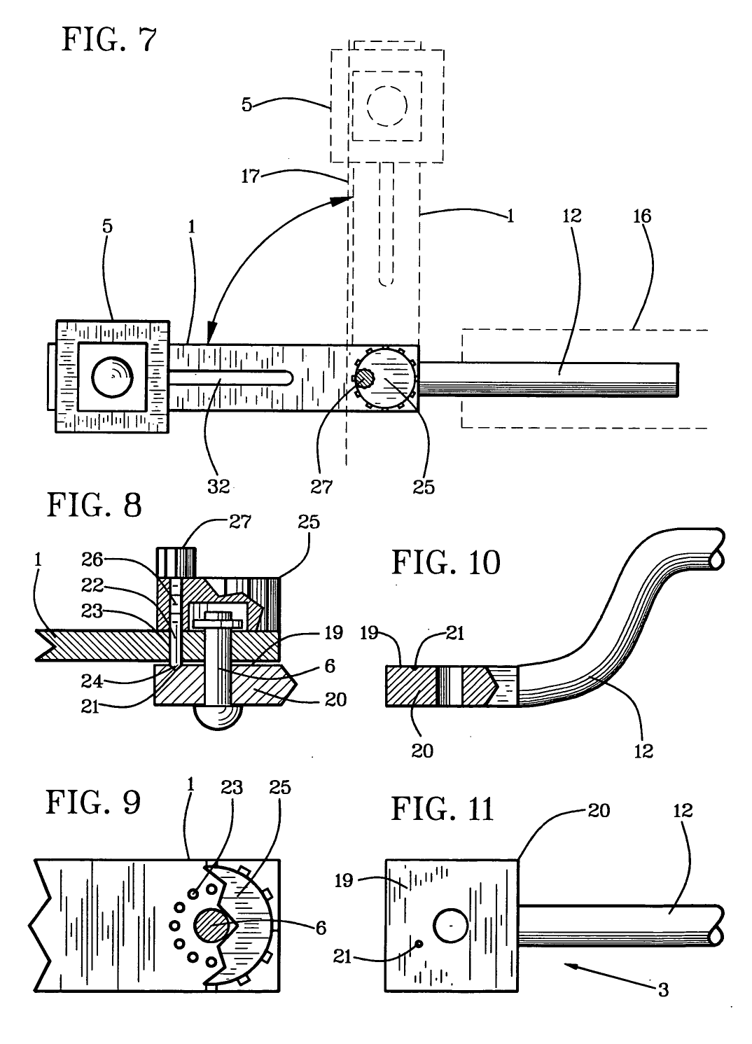

As shown in FIGS. 7 and 12-14, the base bar 1 can include a fastener aperture that is a slot 32 predeterminedly intermediate the latch end and the pivot end of the base bar 1 for positioning the joystick assembly 5 linearly along the base bar 1 selectively.

As shown in FIG. 14, the assembly fastener 31 can include an assembly knob 33 for hand-rotating the assembly fastener 31.

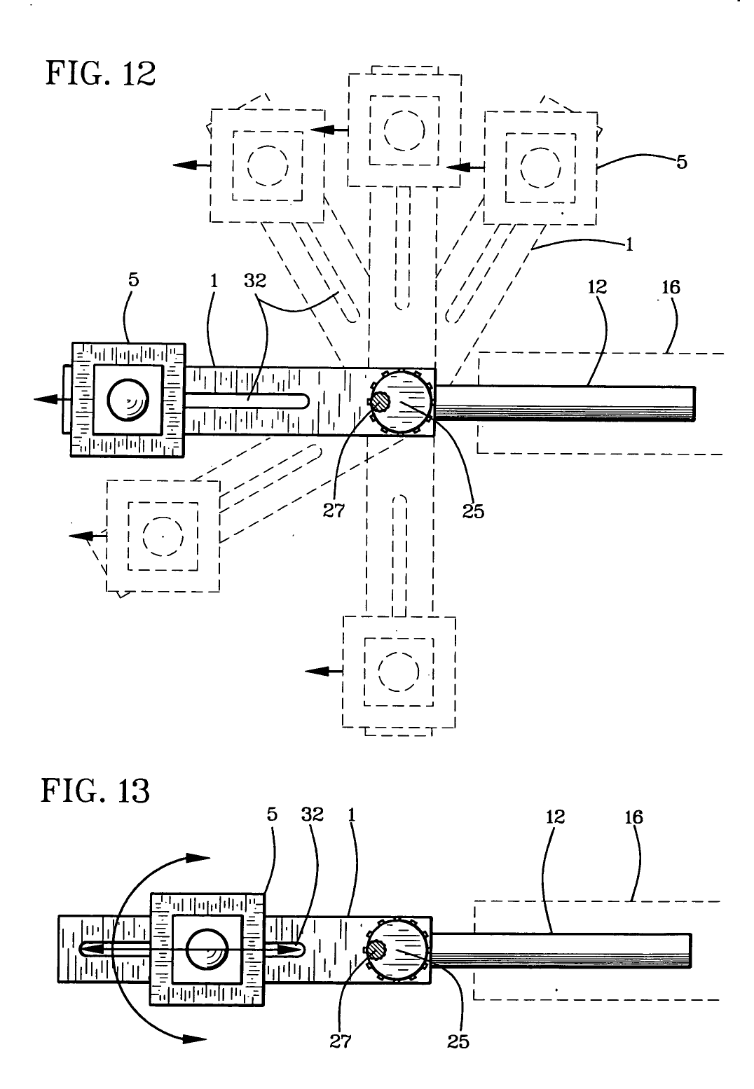

Shown in FIGS. 12-13 is forward rotational positioning of the joystick assembly 5 for control in any direction of rotation to compensate for rotation of the joystick assembly 5 resulting from pivotal positioning of the base bar 1 in combination with linear positioning of the joystick assembly 5 along the base bar 1 selectively.

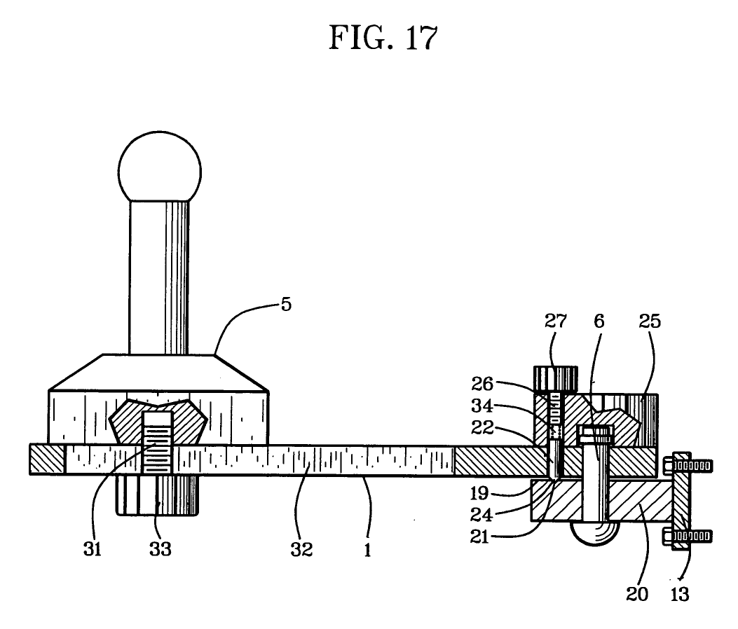

As shown in FIG. 17, the latch 22 can include a resilient section 34 that is affixed to the latch 22 and to the actuator portion 26 at oppositely disposed ends of the resilient section 34 respectively for inserting the latch tip 24 into and removing it from the latch notches 21 selectively by rotation of the latch knob 27. This allows spring-pressured downward travel of the latch tip 24 for finding a latch notch 21 while the base bar 1 is being pivoted in a desired rotational position for the joystick assembly 5. It also provides rigid pivotal positioning of the joystick assembly 5 for its control operation wherever desired within a pivotal range.

A new and useful pivotal joystick base having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A pivotal joystick base comprising:
a base bar having a pivot end and a base end;
the pivot end being pivotal horizontally on a base pivot that is affixed to a chair attachment;
the chair attachment being articulated for attachment to a motorized chair predeterminedly;
the base end being adapted to support a joystick assembly predeterminedly; and
the base pivot having a pivot lock for locking the base bar in a pivoted position selectively.

2. The pivotal joystick base of claim 1 wherein:
the base pivot includes a pivot axle that is oriented vertically on the chair attachment for horizontal pivoting of the base bar; and
the pivot lock includes a spring-pressured member that is spring-pressured upwards vertically into contact with an underside of the base bar and into at least one positional recess in the underside of the base bar for soft-locking the spring-pressured member in the positional recess at a pivotal position of the base bar predeterminedly.

3. The pivotal joystick base of claim 2 wherein:
the spring-pressured member is spring-pressured upwards vertically with a spring having spring pressure variable with an adjustment bolt having an axis that is collinear to an axis of the spring-pressured member for entrance of the spring-pressured member into the positional recess.

4. The pivotal joystick base of claim 3 wherein:
the spring-pressured member is spherical and positioned in a top portion of a lock cylinder in which a helical spring is positioned vertically below the spring-pressured member and the adjustment bolt is threaded into a bottom portion of the lock cylinder for adjusting tension of the helical spring against the spring-pressured member selectively.

5. The pivotal joystick base of claim 1 wherein:
the base pivot includes the lock-notch surface on the chair attachment for horizontal pivoting of the base bar on the pivot axle vertically above the lock-notch surface;
the lock-notch surface includes a predetermined plurality of lock notches positioned predeterminedly circumferential at a design notch distance radially from the pivot axle;
the pivot lock includes a latch that is moveable upwardly and downwardly in a latch aperture in the base rod at the notch distance from the pivot axle;
that latch includes a latch tip that is positioned in a select one of the lock notches for locking the base bar in a selected pivotal direction from the pivot axle;
the latch tip is removed from any of the lock notches for pivoting the base bar to a selected pivotal direction from the pivot axle; and
the lock notches are articulated to receive the latch predeterminedly.

6. The pivotal joystick base of claim 5 wherein:
the latch includes a latch actuator in a bar knob that is affixable to a topside of the pivot end of the base bar.

7. The pivotal joystick base of claim 6 wherein:
that latch actuator includes internal fastener threads in the bar knob and matching external threads in an actuator portion of the latch; and
the latch includes a latch handle for rotating the latch in a downward-rotational direction to screw the latch tip into a select one of the lock notches and for rotating the latch in an upward-rotational direction to unscrew the latch tip from any one of the lock notches.

8. The pivotal joystick base of claim 7 wherein:
the latch handle includes a latch knob.

9. The pivotal joystick base of claim 8 wherein:
the latch tip is conical; and
the lock notches are matched conically concave for receiving the latch tip.

10. The pivotal joystick base of claim 5 wherein:
the latch tip is conical; and
the lock notches are matched conically concave for receiving the latch tip.

11. The pivotal joystick base of claim 1 wherein:
the base bar includes a fastener aperture through which an assembly fastener is inserted and tightened to position the joystick assembly on the base rod.

12. The pivotal joystick base of claim 11 wherein:
the joystick assembly is rotational on the assembly fastener for positioning the joystick assembly in a desired rotational direction for joystick control of the motorized chair with the base bar being pivoted to a select pivotal position.

13. The pivotal joystick base of claim 12 wherein:
the fastener aperture includes a slot predeterminedly intermediate the latch end and the pivot end of the base bar for positioning the joystick assembly linearly along the base bar selectively.

14. The pivotal joystick base of claim 13 wherein:
the assembly fastener includes an assembly knob for hand-rotating the assembly fastener.

15. The pivotal joystick base of claim 1 wherein:
the chair attachment includes an attachment bar that is extended from proximate the base pivot for attachment to the motorized chair predeterminedly.

16. The pivotal joystick base of claim 9 wherein:
the chair attachment includes an attachment bar that is extended from proximate the base pivot for attachment to the motorized chair predeterminedly.

17. The pivotal joystick base of claim 1 wherein:
the chair attachment includes an attachment plate proximate the base pivot; and
the attachment plate includes at least one fastener orifice for attachment to the motorized chair with fasteners predeterminedly.

18. The pivotal joystick base of claim 9 wherein:
the chair attachment includes an attachment plate proximate the base pivot; and
the attachment plate includes at least one fastener orifice for attachment to the motorized chair with fasteners predeterminedly.

19. The pivotal joystick base of claim 1 and further comprising:
a stop on a bottom side of the base bar for contacting the chair attachment to prevent inward pivoting of the base bar to a position of contact of the base end with a front portion of a user.

20. The pivotal joystick base of claim 18 wherein:
the latch knob is a flush knob that is recessed in a knob bay in the bar knob.

21. The pivotal joystick base of claim 9 wherein:
the latch includes a resilient section that is affixed to the latch at oppositely disposed ends of the resilient section for inserting the latch tip into and removing it from the latch notch selectively.
